(19) United States
(12) Patent Application Publication
(10) Pub. No.: US 2020/0048955 A1
(43) Pub. Date: Feb. 13, 2020

(54) PLUG CONNECTOR

(71) Applicant: SAINT-GOBAIN GLASS FRANCE, Courbevoie (FR)

(72) Inventors: Walter SCHREIBER, Aachen (DE); Hans-Werner KUSTER, Aachen (DE); Andreas GEITH, Traunstein (DE)

(73) Assignee: Saint-Gobain Glass France, Courbevoie (FR)

(21) Appl. No.: 16/339,268

(22) PCT Filed: Oct. 10, 2017
(86) PCT No.: PCT/EP2017/075740

§ 371 Date: Apr. 3, 2019

(30) Foreign Application Priority Data
Oct. 11, 2016 (FR) 16193307.2

(51) Int. Cl. E06B 3/667; F16B 7/04; E06B 3/663; E06B 3/673

(52) U.S. Cl. CPC E06B 3/667; F16B 7/0446; E06B 3/67308; E06B 3/66366; E06B 3/66314

(57) ABSTRACT

A plug connector for connecting a first spacer and a second spacer for a triple insulating glazing unit, includes a main body and a first and a second section. The first section of the main body and/or the second section of the main body is movable around a specified axis of the main body.

The invention relates to a plug connector, a triple insulating glazing unit, a method for producing an insulating glazing unit, and the use of a plug connector in multiple glazing units.

Generic plug connectors are used for connecting spacers for insulating glazing units. Such plug connectors have a main body. A leg that is insertable into a hollow chamber of a first spacer can be arranged on a first section of the main body, wherein the first leg is arranged substantially perpendicular to a surface of the first section.

A second leg that is insertable into a hollow chamber of a second spacer can be arranged on a second section of the main body, wherein the the second leg is arranged substantially perpendicular to a surface of the second section of the main body.

A closed frame that is arranged between two glass panes to form a two-pane insulating glass pane is formed by connecting the spacers by means of the plug connectors. In three-pane insulating glazing units, two spacer frames and three glass panes must be coordinated and joined to one another.

A corresponding spacer for triple insulating glazing units is known from the document WO 2014/198431 A1. This comprises a polymeric main body with a wall thickness comprising a first pane contact surface and a second pane contact surface extending parallel thereto, a first glazing unit interior surface, a second glazing unit interior surface, an outer surface, a first hollow chamber, and a second hollow chamber. A groove for accommodating a pane extends parallel to the first pane contact surface and second pane contact surface between the first glazing unit interior surface and the second glazing unit interior surface. The first hollow chamber adjoins the first glazing unit interior surface and the second hollow chamber adjoins the second glazing unit interior surface. The side flanks of the groove are formed by the walls of the first hollow chamber and the second hollow chamber. Moreover, the wall thickness in the region of the side flanks is less than the wall thickness of the polymeric main body.

Known from U.S. Pat. No. 4,357,744 are connector elements for connecting frame parts for glass panels. These connector elements have a flexible central section such that they can be bent. The connector elements according to U.S. Pat. No. 4,357,744 are, however, unsuitable for triple insulating glazing units, in which three individual panes must be held at a distance from one another via corresponding spacers. Also, U.S. Pat. No. 4,628,582 as well as WO 92/18777 A1 describe connector elements for spacers of double glazing units that can be bent. These connector elements as well are, however, unsuitable for triple glazing units. Furthermore, in U.S. Pat. No. 4,628,582, one of four corner connectors is not flexible, but, instead, rigid.

Furthermore, with regard to the prior art, reference is also made to WO 2006/076934 A1. There, however, rigid connector elements are presented. To be sure, flexible elements are also presented. These are, however, not used to connect multiple spacers to one another, but, instead, merely have a shape-defining function (in the respective corner region) and are used in one and the same spacer (which is also flexible).

A connector element for spacers for triple insulating glazing units is, for example, known from DE 10 2014 110 549 A1. The connector element there is rigid and also structured such that it cannot be flexible (as, for example, the connector elements for double glazing units in U.S. Pat. No. 4,357,744). In this context, it should be noted that a connector element for triple insulating glazing units in accordance with DE 10 2014 110 549 A1 differs fundamentally from a connector element for double insulating glazing units, such as in U.S. Pat. No. 4,357,744, since in a connector element for triple insulating glazing units, all the panes cannot simply be arranged on opposing edges of the spacer such that, in principle, other requirements must be met.

The object of the invention is to provide a plug connector that enables simplified assembly of a triple insulating glazing unit as well as to provide an economical method for assembling a triple insulating glazing unit having a plug connector according to the invention.

The object of the present invention is accomplished according to the invention by a plug connector, a triple insulating glazing unit, a method for producing an insulating glazing unit, as well as the use of a plug connector in multiple glazing units according to the independent claims 1, 8, 9, and 15.

The present invention provides a plug connector for connecting a first spacer and a second spacer for a triple insulating glazing unit, wherein the first section of the main body and/or the second section of the main body is movable around a specified axis of the main body.

The present invention further provides a triple insulating glazing unit having at least one first pane, one second pane, one third pane, and a plurality of circumferentially arranged spacers surrounding the at least first pane, the second pane, and third pane in edge regions, wherein on a first pane edge of the first pane, of the second pane, and of the third pane, a first spacer is arranged in each case; on a second pane edge of the first pane, of the second pane, and of the third pane, a second spacer is arranged in each case, a third spacer is arranged in each case on a third pane edge of the first pane, of the second pane, and of the third pane spacer; and a fourth spacer is arranged in each case on a fourth pane edge of the first pane, of the second pane, and of the third pane, and wherein the plug connector for connecting adjacent spacers is arranged on the respective axial end sections.

The invention also provides a method for producing an insulating glazing unit. The method includes providing a plurality of spacers comprising a first spacer, a second spacer, a third spacer, and a fourth spacer, which are implemented in each case for accommodating at least a first pane, a second pane, and a third pane of an insulating glazing unit. The method also includes connecting the first spacer and the second spacer by means of a first plug connector. The method includes, moreover, connecting the second spacer and the third spacer by means of a second plug connector. The method additionally includes connecting the third spacer and the fourth spacer by means of a third plug connector. The method further includes connecting the fourth spacer and the first spacer by means of a fourth plug connector. The method also includes butylating the plurality of spacers, wherein the plurality of spacers connected by means of the plug connector are arranged in a row along a common longitudinal axis in a butylator.

The present invention also provides use of the plug connector according to the invention in triple insulating glazing units.

The expression “triple insulating glazing unit” means an insulating glazing unit that comprises exactly three or more than three panes, wherein between adjacent panes an intermediate space is formed, which can, for example, be filled with a gas and/or can be (partially) evacuated.

The expression “connecting spacers” means, in particular, that the spacers are previously present separate (i.e., are not connected to one another) and are joined to one another only by the respective plug connector. The two spacers to be connected are thus implemented, in particular, as two parts removable from one another in their initial or pre-assembly state.

The respective plug connector is preferably one piece, in particular, monolithic. The expression “one-piece design” means, in particular, a design in which individual elements of the respective plug connector cannot be removed (without breaking a fixed connection). The expression “fixed connection” means, in particular, a substance-to-substance bond. This does not preclude the possibility that individual sections of the respective plug connector according to the invention can be moved toward one another or away from one another (so long as these individual sections are connected to one another, for example, in an articulated manner).

One idea of the present invention is to provide, due to the movability of the first section of the main body and/or of the second section of the main body around the specified axis of the main body, a plug connector for connecting a first spacer and a second spacer for a triple insulating glazing unit which has, during production of the triple insulating glazing unit or during assembly of the triple insulating glazing unit, both improved process reliability and also an economically improved efficient assembly method.

In the context of known solutions, the step of butylation of the spacers is done in that these are already placed on the glazing unit and a spacer placed on the respective pane edge is conveyed through a butylator, in which a butyal application is done on corresponding sides of the spacer. This operation must be repeated for every spacer arranged on a respective window in the edge, in other words, in the case of a four-edged pane, the aforementioned method must carried out a total of four times.

In contrast, the plug connector according to the invention enables, due to its movability of the first section of the main body and/or of the second section of the main body around the specified axis of the main body, respective plug connectors to be connected to the corresponding spacers before carrying out the butylation; however, the pane does not yet have to be connected to the spacers. The plug connectors connected to the spacers can thus be transported substantially flat through the butylator. This yields the advantage that for butylating the spacers only a single pass of the spacers already connected to the plug connectors through the butylator is required.

Attachment of the spacers connected to the plug connectors on a respective pane can thus be done in a subsequent step. The implementation according to the invention of the plug connector with the movability of the first section of the main body and/or of the second section of the main body around the specified axis of the main body thus enables improved process reliability during the butylating of the spacers since no rotation or re-insertion of the spacers into the butylator has to be carried out, which can result in a nonuniform butyl application on the spacers, wherein, for example, either excessive or inadequate application of butyl on the spacers is possible.

With the assembly of plug connectors and spacers according to the invention that can be transported substantially flat through the butylator, a uniform butyl application on the spacers can thus be carried out. In addition, shorter times can be realized in the assembly of the insulating glazing unit and and thus the method for producing the insulating glazing unit can be designed more efficiently.

Advantageous embodiments and developments emerge from the dependent claims as well as from the description with reference to the figures.

Provision is made according to a preferred development for the main body to be implemented such that the first section of the main body and/or the second section of the main body is bendable or foldable around a longitudinal axis of the main body. This preferably enables realization of different positions of the plug connector for different stages of the method for producing the insulating glazing unit. For example, in the step for butylation of the spacers, the plug connector can be arranged flat; and during assembly of the spacers connected by means of the plug connectors, the plug connectors can be bent or folded around the longitudinal axis of the main body of the respective plug connector.

According to another preferred development, provision is made for the main body to be arranged in a pre-assembly position of the plug connector such that the first leg arranged on the first section of the main body and the second leg arranged on the second section of the main body are arranged substantially parallel to one another, and for the main body to be arranged in an assembly position of the plug connector such that the first leg arranged on the first section of the main body and the second leg arranged on the second section of the main body are arranged substantially perpendicular to one another. As a result of the above embodiment of the plug connector, increased flexibility can thus be advantageously achieved during the assembly of the insulating glazing unit.

According to another preferred development, provision is made for the plug connector to have a third leg arranged on the first section of the main body that is insertable into another hollow chamber of the first spacer, wherein the third leg is arranged substantially perpendicular to the surface of the first section of the main body, and wherein the plug connector has a fourth leg arranged on the second section of the main body that is insertable into another hollow chamber of the second spacer, wherein the fourth leg is arranged substantially perpendicular to the surface of the second section. As a result of provision of the third leg and the fourth leg of the plug connector, a plug connector that is suitable for connecting spacers for a triple insulating glazing unit can be advantageously realized. Thus, the advantages of the movability of the first section and/or of the second section of the main body around the specified axis, in other words, the adjustability of the plug connector from the pre-assembly position into the assembly position in a simple manner, can be used for triple glazing.

According to another preferred improvement, provision is made for the main body to have a first recess substantially V-shaped in a cross-section of the main body that is arranged symmetric to the specified axis of the main body, wherein a first side face of the V-shaped first recess has an angle greater than or equal to 90° relative to a second side face of the V-shaped first recess.

The arrangement of the first side face of the V-shaped first recess relative to the second side face of the V-shaped first recess with a angle greater than or equal to 90° preferably enables the angle between the first side face and the second side face to be closed such that the first leg of the plug connector can be arranged substantially perpendicular to the second leg of the plug connector or the third leg of the plug connector can be arranged substantially perpendicular to the fourth leg of the plug connector.

According to another preferred development, provision is made for the main body to have, in a region substantially central in a longitudinal direction, a second recess implemented along a width of the main body that is implemented to accommodate a pane of the insulating glazing unit, wherein a bottom section of the second recess is flat. Thus, the pane of the insulating glazing unit can preferably be accommodated, in the pre-assembly state of the plug connector, in the second recess implemented along the width of the main body; and the main body can subsequently be bent or folded around its longitudinal axis for transferring into the assembly position, wherein, advantageously, a simple and reliable positioning of the plug connector relative to the pane is possible.

According to another preferred development, provision is made for the main body to have a latching device that is implemented, in the assembly position of the plug connector, to lock the first section of the main body on the second section of the main body or vice versa. Thus, the plug connector can preferably be locked in the assembly position, making it possible for a respective plug connector as well as the spacer connected thereto to be held in position, after assembly, on the respective pane.

According to another preferred development, provision is made for the plurality of spacers to be transported only once through the butylator during butylation. As a result, advantageously, the cycle times during production of the insulating glazing unit can be reduced and the process reliability can be improved by the uniform butyl application.

According to another preferred development, provision is made for the butylated plurality of spacers to be folded around the at least first pane, second pane, and third pane of the insulating glazing unit. The folding of the plurality of spacers connected to one another by the plug connectors around the at least first pane, second pane, and third pane of the insulating glazing unit simplifies the production of the insulating glazing unit since the respective pane does not have to already be connected to the spacers at the time of butylation, but, instead, the butylated plurality of spacers that are connected to the respective plug connectors are not folded around the pane until a step downstream from the butylation.

According to another preferred development, provision is made, during the folding of the plurality of spacers around the at least first pane, second pane, and third pane of the insulating glazing unit, for the first section of the main body of the respective plug connector and/or the second section of the main body of the respective plug connector to be moved around a specified axis of the main body in order to bring the plug connector from the pre-assembly position into the assembly position. Thus, efficient assembly of the insulating glazing unit can advantageously be achieved with shortened cycle times.

According to another preferred development, provision is made, during the movement of the plug connector from the pre-assembly position into the assembly position, for the first leg arranged on the first section of the main body and the second leg arranged on the second section of the main body to be brought from an arrangement substantially parallel to one another into an arrangement substantially perpendicular to one another. As a result of the above design of the plug connector, increased flexibility can thus be advantageously achieved during the assembly of the insulating glazing unit.

According to another preferred development, provision is made, during the movement of the plug connector from the pre-assembly position into the assembly position, for the third leg arranged on the first section of the main body and the fourth leg arranged on the second section of the main body to be brought from an arrangement substantially parallel to one another into an arrangement substantially perpendicular to one another. As a result of the above design of the plug connector, increased flexibility can thus be advantageously achieved during the assembly of the insulating glazing unit.

According to another preferred development, provision is made for the plurality of spacers to be implemented for accommodating the third pane of the insulating glazing unit, wherein the third pane is inserted into the second recess formed in the main body. Thus, the pane of the insulating glazing unit can preferably be accommodated, in the pre-assembly state of the plug connector, in the second recess formed along the width of the main body; and the main body can subsequently be bent or folded around its longitudinal axis for transfer into the assembly position, wherein, advantageously, simple and reliable positioning of the plug connector relative to the pane is possible.

The the embodiments and developments described can be combined with one another as desired.

Further possible embodiments, developments, and implementations of the invention also include combinations not explicitly mentioned of features of the invention described above or in the following with regard to the exemplary embodiments.

### BRIEF DESCRIPTION OF THE DRAWINGS

The accompanying drawings are intended to provide further understanding of the embodiments of the invention. They illustrate embodiments and serve in conjunction with the description to explain principles and concepts of the invention.

Other embodiments and many of the advantages mentioned emerge with reference to the drawings. The elements of the drawings presented are not necessarily depicted true to scale relative to one another.

The drawings depict:

FIG. 1 a schematic representation of a plug connector in a pre-assembly position according to one example;

FIG. 2 a schematic representation of the plug connector of FIG. 1 in an assembly position;

FIG. 3 a schematic representation of the plug connector in the pre-assembly position according to a preferred embodiment of the invention;

FIG. 4 a schematic representation of the plug connector in the assembly position according to the preferred embodiment of the invention;

FIG. 5 a schematic representation of a two-pane insulating glazing unit according to one example;

FIG. 6 a schematic representation of a three-pane insulating glazing unit according to the preferred embodiment of the invention;

FIG. 7 a schematic representation of a butylator; and

FIG. 8 a flowchart of a method for producing the insulating glazing unit according to the preferred embodiment of the invention.

In the figures, identical reference characters refer to identical or functionally identical elements, parts, or components, unless otherwise indicated.

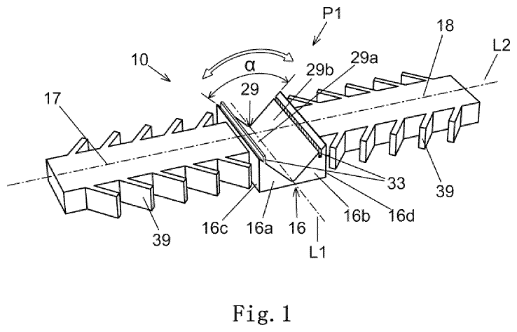

FIG. 1 depicts a schematic representation of a plug connector in a pre-assembly position according to one example.

The plug connector 10 is designed to connect a first spacer (not shown in FIG. 1) and a second spacer (not shown in FIG. 1) for an insulating glazing unit. The plug connector 10 has a main body 16. A first leg 17 is arranged on a first section 16a of the main body 16. The first leg 17 can be inserted into a hollow chamber of the spacer (not shown in FIG. 1). The first leg 17 is arranged substantially perpendicular to a surface 16c of the first section 16a.

The first leg 17 further has a plurality of sealing lips 39. The sealing lips 39 are arranged on a first side and on a second side of the substantially cube-shaped first leg 17 and serve to seal the hollow chamber filled with molecular sieve such that in an inserted state of the first leg 17 of the plug connector 10 into the hollow chamber of the first spacer, no molecular sieve escapes from the hollow chamber.

The plug connector 10 further has a second leg 18 arranged on a second section 16b of the main body 16. The second leg 18 can be inserted into a hollow chamber of the second spacer (not shown in FIG. 1). The second leg 18 is arranged substantially perpendicular to a surface 16d of the second section 16b of the main body 16.

Furthermore, the second leg has a plurality of sealing lips 39. The sealing lips 39 are arranged on a first side and on a second side of the substantially cube-shaped second leg 18 and serve to seal the hollow chamber filled with molecular sieve such that in an inserted state of the second leg 18 of the plug connector 10 into the hollow chamber of the second spacer, no molecular sieve escapes from the hollow chamber.

The first section 16a of the main body 16 and the second section 16b of the main body 16 are bendable around a longitudinal axis L1 of the main body 16. Alternatively, the first section 16a of the main body 16 or the second section 16b of the main body 16 are bendable around the longitudinal axis L1 of the main body 16. Also alternatively, the first section 16a of the main body 16 and/or the second section 16b of the main body 16 can be foldable around the longitudinal axis L1 of the main body or movable or pivotable by another suitable device.

The main body 16 preferably has a substantially V-shaped first recess 29 in a cross-section of the main body 16. The V-shaped first recess 29 is advantageously arranged symmetric to the specified axis or longitudinal axis L1 of the main body 16. A first side face 29a of the V-shaped first recess 29 preferably has an angle a greater than or equal to 90° relative to a second side face 29b of the V-shaped first recess 29.

Furthermore, the main body 16 preferably has a latching device 33. The latching device 33 is preferably designed, in an assembly position (not shown in FIG. 1) of the plug connector, to lock the first section 16a of the main body 16 on the second section 16b of the main body. Alternatively, the latching device 33 can, for example, be designed such that the second section 16b of the main body 16 can be locked on the first section 16a of the main body 16.

The main body 16 is, in the pre-assembly position P1 of the plug connector 10 depicted in FIG. 1, preferably arranged such that the first leg 17 arranged on the first section 16a of the main body 16 and the second leg 18 arranged on the second section 16b of the main body 16 are arranged substantially parallel to one another or along a common longitudinal axis L2.

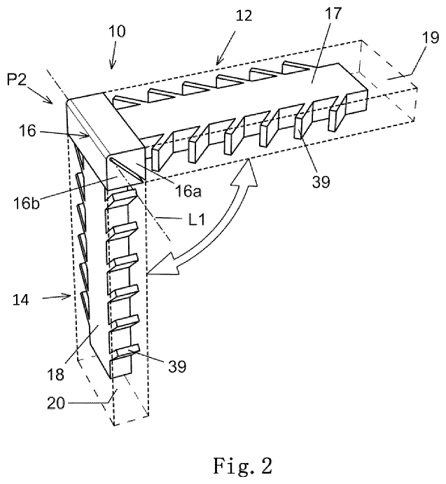

FIG. 2 depicts a schematic representation of the plug connector of FIG. 1 in an assembly position.

In the assembly position P2 of the plug connector 10, the main body 16 is preferably arranged such that the first leg 17 arranged on the first section 16a of the main body 16 and the second leg 18 arranged on the second section 16b of the main body 16 are arranged substantially perpendicular to one another.

In the schematic representation of the plug connector depicted in FIG. 2, in the assembly position P2 of the plug connector 10, a gap is formed between the first section 16a of the main body 16 and the second section 16b of the main body 16. The aforementioned gap serves only to illustrate movability of the first section 16a of the main body 16 and of the second section 16b of the main body 16 relative to one another. In the assembly position P2, this gap is preferably not present. In the representation of FIG. 2, the first leg 17 of the main body 16 is inserted into a (schematically depicted) hollow chamber 19 of the first spacer and the second leg 18 is inserted into a hollow chamber 20 of the second spacer.

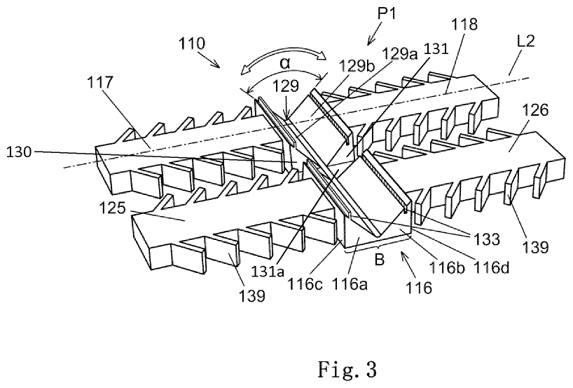

FIG. 3 depicts a schematic representation of the plug connector in the pre-assembly position according to a preferred embodiment of the invention.

The plug connector 110 depicted in FIG. 3 has, in contrast to the plug connector depicted in in FIG. 1 and FIG. 2, in addition to the first leg and the second leg, a third leg and a fourth leg and is thus suitable to be inserted in a spacer for triple glazing units.

The plug connector 110 preferably has the third leg 125 arranged on the first section 116a of the main body 116. The third leg 125 is insertable into another hollow chamber (not depicted in FIG. 3) of the first spacer. The third leg 125 is arranged substantially perpendicular to the surface 116c of the first section 116a of the main body 116.

The plug connector 110 also has the fourth leg 126 arranged on the second section 116b of the main body 116. The fourth leg 126 is preferably insertable into another hollow chamber (not depicted in FIG. 3) of the second spacer, wherein the fourth leg 126 is arranged substantially perpendicular to the surface 116d of the second section 116b.

The main body 116 of the plug connector 110 has, preferably in a region 130 substantially central in a longitudinal direction, a second recess 131 formed along a width B of the main body 116. The second recess 131 is preferably implemented to accommodate a pane (not depicted in FIG. 3) of the insulating glazing unit. A bottom section 131a of the second recess 131 is preferably flat.

The main body 116 has a latching device 133. The latching device 133 is preferably implemented to lock, in the assembly position P2 of the plug connector 110, the first section 116a of the main body 116 on the second section 116b of the main body 116. Alternatively, the second section 116b of the main body 116 can, for example, be locked on the first section 116a of the main body 116.

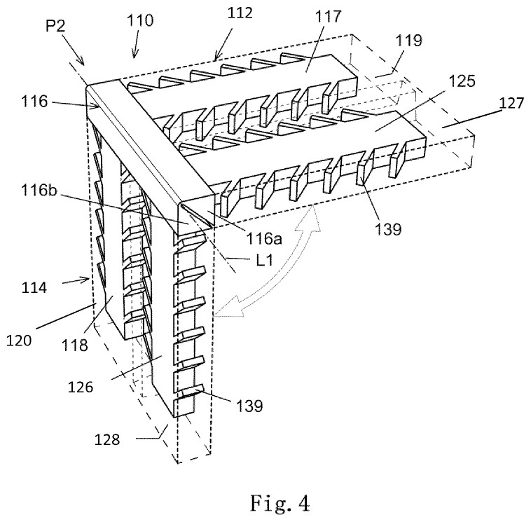

FIG. 4 depicts a schematic representation of the plug connector in the assembly position according to the preferred embodiment of the invention.

In the assembly position P2 of the plug connector 110, the main body 116 is preferably arranged such that the first leg 117 and third leg 125 arranged on the first section 116a of the main body 116 as well as the second leg 118 and fourth leg 126 arranged on the second section 116b of the main body 116 are arranged substantially perpendicular to one another.

In the schematic representation of the plug connector 110 depicted in FIG. 4, in the assembly position P2 of the plug connector 110, a gap is formed between the first section 116a of the main body 116 and the second section 116b of the main body 116. The aforementioned gap serves merely to illustrate the movability of the first section 116a of the main body 116 and of the second section 116b of the main body 116 relative to one another. This gap is preferably not present in the assembly position P2. In the representation of FIG. 4, the first leg 117 and the third leg 125 of the main body 116 are inserted into (schematically depicted) hollow chambers 119, 127 of the first spacer 112; and the second leg 118 and the fourth leg 126 are inserted into a hollow chambers 120, 128 of the second spacer 114.

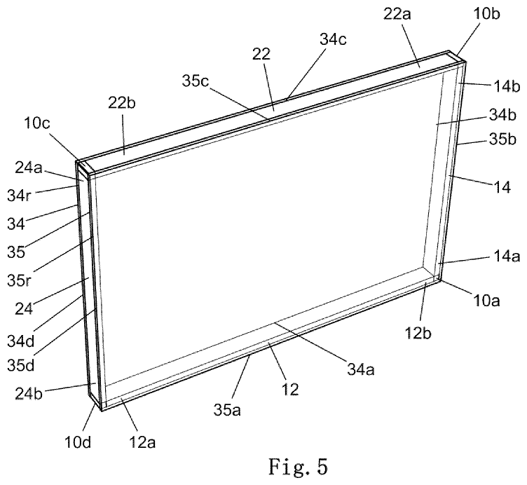

FIG. 5 depicts a schematic representation of a two-pane insulating glazing unit according to one example.

The insulating glazing unit preferably has a first pane 34 and a second pane 35. Furthermore, the insulating glazing unit has a plurality of circumferentially arranged spacers 12, 14, 22, 24 surrounding the first pane 34 and second pane 35 in edge regions 34r, 35r. A first spacer 12 is arranged in each case on a first pane edge 34a, 35a of the first pane 34 and of the second pane 35. A second spacer is arranged in each case on a second pane edge 34b, 35b of the first pane 34 and of the second pane 35. A third spacer 22 is in each case arranged on a third pane edge 34c, 35c of the first pane 34 and of the second pane 35. A fourth spacer 24 is in each case arranged on a fourth pane edge 34d, 35d of the first pane 34 and of the second pane 35.

A plug connector 10a, 10b, 10c, 10d for connecting adjacent spacers 12, 14, 22, 24 is preferably arranged on respective axial end sections 12a, 12b, 14a, 14b, 22a, 22b, 24a, 24b of the spacers 12, 14, 22, 24.

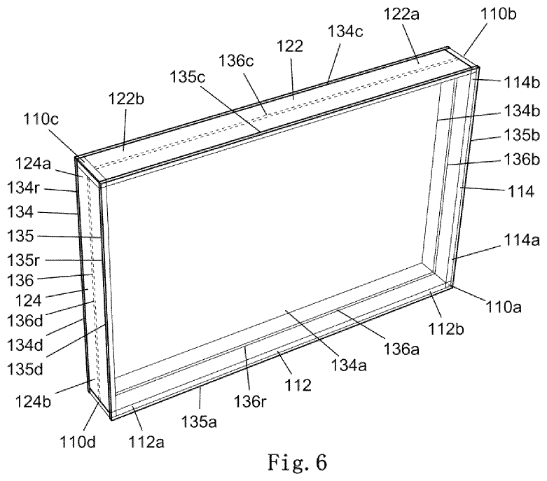

FIG. 6 depicts a schematic representation of a three-pane insulating glazing unit according to the preferred embodiment of the invention.

A second spacer 114 is in each case arranged on a second pane edge 134b, 135b, 136b of the first pane 134, of the second pane 135, and of the third pane 136. A third spacer 122 is in each case arranged on a third pane edge 134c, 135c, 136c of the first pane 134, of the second pane 135, and of the third pane 136. A fourth spacer is in each case arranged on a fourth pane edge 134d, 135d, 136d of the first pane 134, of the second pane 135, and of the third pane 136. A plug connector 110a, 110b, 110c, 110d for connecting the adjacent spacers 112, 114, 122, 124 is preferably arranged on respective axial end sections 112a, 112b, 114a, 114b, 122a, 122b, 124a, 124b of the spacers 112, 114, 122, 124.

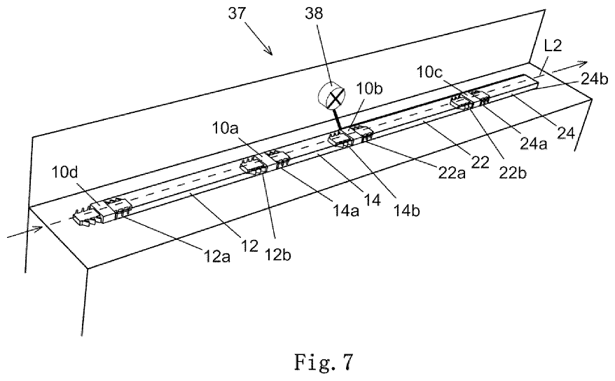

FIG. 7 depicts a schematic representation of a butylator.

During butylation of the plurality of spacers 12, 14, 22, 24, which are preferably connected on respective axial end sections 12a, 12b, 14a, 14b, 22a, 22b, 24a, 24b to a respective plug connector 10a, 10b, 10c, 10d, they are transported through the butylator 37 in preferably flat alignment. An applicator 38 for applying butyl on the plurality of spacers 12, 14, 22, 24 is depicted by way of example. The applicator is preferably arranged on both sides of the spacers 12, 14, 22, 24 such that during transport through the butylator 37, they can be applied with butyl on both sides.

A corresponding butylator is also suitable for butylation of spacers 112, 114, 122, 124, which are preferably connected on respective axial end sections 112a, 112b, 114a, 114b, 122a, 122b, 124a, 124b to a respective plug connector 110a, 110b, 110c, 110d.

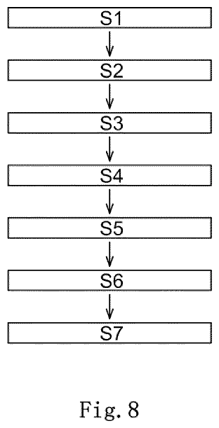

FIG. 8 depicts a flowchart of a method for producing the insulating glazing unit according to the preferred embodiment of the invention.

The method for producing an insulating glazing unit includes providing S1 a plurality of spacers comprising a first spacer, a second spacer, a third spacer, and a fourth spacer. The respective spacers are implemented in each case for accommodating at least a first pane, a second pane, and a third pane of an insulating glazing unit. The method also includes connecting S2 the first spacer and the second spacer by means of a first plug connector; connecting S3 the second spacer and the third spacer by means of a second plug connector; connecting S4 the third spacer and the fourth spacer by means of a third plug connector; connecting S5 the fourth spacer and the first spacer by means of a fourth plug connector; and butylating S6 the plurality of spacers.

The plurality of spacers connected by means of the plug connectors are arranged in the butylator along a common longitudinal axis. In a following step, the butylated plurality of spacers are folded around the at least first pane, second pane, and third pane of the insulating glazing unit S7. The plurality of spacers are thus implemented for accommodating a third pane of the insulating glazing unit. The third pane of the insulating glazing unit is insertable into the second recess formed in the main body.

During the folding of the plurality of spacers around the at least first pane, second pane, and third pane of the insulating glazing unit, the first section of the main body of the respective plug connector and the second section of the main body of the respective plug connector are moved around a longitudinal axis of the main body in order to bring the plug connector from the pre-assembly position into the assembly position. Alternatively, for example, only the first or the second section of the main body can be movable.

During the movement of the plug connector from the pre-assembly position into the assembly position, the first leg arranged on the first section of the main body and the second leg arranged on the second section of the main body are preferably brought from an arrangement substantially parallel to one another into an arrangement substantially perpendicular to one another.

Although the present invention has been described above with reference to preferred exemplary embodiments, it is not restricted thereto, but rather modifiable in many ways. In particular, the invention can be altered or modified without deviating from the essence of the invention.

For example, a shape, dimension, or nature of the components of the plug connector can be altered.

### LIST OF REFERENCE CHARACTERS

10, 110 plug connector
10a, 110a first plug connector
10b, 110b second plug connector
10c, 110c third plug connector
10d, 110d fourth plug connector
12, 112 first spacer
12a, 12b, 112a, 112b axial end sections of the first spacer
14, 114 second spacer
14a, 14b, 114a, 114b axial end sections of the second spacer
16, 116 main body
16a, 116a first section of the main body
16b, 116b second section of the main body
16c, 116c surface of the first section
16d, 116d surface of the second section
17, 117 first leg
18, 118 second leg
19, 119, 127 hollow chamber of the first spacer
20, 120, 128 hollow chamber of the second spacer
22, 24 spacer
22a, 22b, 122a, 122b axial end sections of the third spacer
24a, 24b, 124a, 124b axial end sections of the fourth spacer
29, 129 first recess
29a first side face of the first recess
29a second side face of the first recess
30, 130 central region
33, 133 latching device
34, 134 first pane
34r, 35r edge regions
35, 135 second pane
34a, 35a, 134a, 135a, 136a first pane edge
34b, 35b, 134b, 135b, 136b second pane edge
34c, 35c, 134c, 135c, 136c third pane edge
34d, 35d, 134d, 135d, 136d fourth pane edge
37 butylator
38 applicator
39, 139 sealing lips
122, 124 spacer
125 third leg
126 fourth leg
131 second recess
131a bottom section of the second recess
134r, 135r, 136r edge regions
136 third pane
α angle
B width
L1 longitudinal axis of the main body
L2 longitudinal axis
P1 pre-assembly position
P2 assembly position

1. A plug connector for connecting a first spacer and a second spacer for a triple insulating glazing unit, the plug connector comprising a main body;
a first leg arranged on a first section of the main body, which first leg is insertable into a hollow chamber of the first spacer, wherein the first leg is arranged substantially perpendicular to a surface of the first section; and
a second leg arranged on a second section of the main body, which second leg is insertable into a hollow chamber of the second spacer, wherein the second leg is arranged substantially perpendicular to a surface of the second section of the main body, wherein the first section of the main body and/or the second section of the main body is movable around a specified axis of the main body.

2. The plug connector according to claim 1, wherein the main body is implemented such that the first section of the main body and/or the second section of the main body is bendable or foldable around a longitudinal axis of the main body.

3. The plug connector according to claim 1, wherein the main body is arranged in a pre-assembly position of the plug connector such that the first leg arranged on the first section of the main body and the second leg arranged on the second section of the main body are arranged substantially parallel to one another, and wherein the main body is arranged in an assembly position of the plug connector such that the first leg arranged on the first section of the main body and the second leg arranged on the second section of the main body are arranged substantially perpendicular to one another.

4. The plug connector according to claim 1, further comprising a third leg arranged on the first section of the main body, which third leg is insertable into another hollow chamber of the first spacer, wherein the third leg is arranged substantially perpendicular to the surface of the first section of the main body, and a fourth leg arranged on the second section of the main body, which fourth leg is insertable into another hollow chamber of the second spacer, wherein the fourth leg is arranged substantially perpendicular to the surface of the second section.

5. The plug connector according to claim 1, wherein the main body has a first recess substantially V-shaped in a cross-section of the main body, which recess is arranged symmetric to the specified axis of the main body, wherein a first side face of the V-shaped first recess has an angle (α) greater than or equal to 90° relative to a second side face of the V-shaped first recess.

6. The plug connector according to claim 5, wherein the main body has, in a region substantially central in a longitudinal direction, a second recess implemented along a width of the main body, which is implemented to accommodate a pane of the insulating glazing unit, wherein a bottom section of the second recess is flat.

7. The plug connector according to claim 3, wherein the main body has a latching device, which, in the assembly position of the plug connector, is implemented to lock the first section of the main body on the second section of the main body or vice versa.

8. An insulating glazing unit with a first pane, a second pane ( ), a third pane ( ), and a plurality of circumferentially arranged spacers ( , , , ) surrounding the first pane ( ), second pane, ( ), and third pane ( ) in edge regions, wherein a first spacer is in each case arranged on a first pane edge of the first pane, of the second pane, and of the third pane; a second spacer is in each case arranged on a second pane edge of the first pane, of the second pane, and of the third pane; a third spacer is in each case arranged on a third pane edge of the first pane, of the second pane, and of the third pane; and a fourth spacer is in each case arranged on a fourth pane edge of the first pane, of the second pane, and of the third pane, and wherein, on the respective axial end sections of the spacers, a plug connector according to claim 1 for connecting adjacent spacers is arranged.

9. A method for producing an insulating glazing unit according to claim 8, comprising:
providing a plurality of spacers comprising a first spacer, a second spacer, a third spacer, and a fourth spacer, which are in each case implemented to accommodate a first pane, a second pane, and a third pane of an insulating glazing unit;
connecting the first spacer and the second spacer by means of a first plug connector;
connecting the second spacer and the third spacer by means of a second plug connector;
connecting the third spacer and the fourth spacer by means of a third plug connector;
connecting the fourth spacer and the first spacer by means of a fourth plug connector; and
butylating the plurality of spacers, wherein the plurality of spacers connected by means of the plug connectors are arranged in a row in a butylator along a common longitudinal axis.

10. The method according to claim 9, wherein during butylation of the plurality of spacers, the plurality of spacers are transported only once through the butylator.

11. The method according to claim 9, wherein the butylated plurality of spacers are folded around the at least first pane, second pane, and third pane of the insulating glazing unit.

12. The method according to claim 11, wherein during the folding of the plurality of spacers ( , , , ) around the first pane, second pane, and third pane of the insulating glazing unit, the first section of the main body of the respective plug connector and/or the second section of the main body of the respective plug connector is moved around a specified axis of the main body in order to bring the plug connector from the pre-assembly position into the assembly position.

13. The method according to claim 12, wherein during the movement of the plug connector from the pre-assembly position into the assembly position, the first leg arranged on the first section of the main body and the second leg arranged on the second section of the main body are brought from a substantially parallel arrangement relative to one another into a substantially perpendicular position relative to one another.

14. The method according to claim 9, wherein the third pane is inserted into a second recess formed in the main body.

15. A method comprising utilizing a plug connector according to claim 1 in triple insulating glazing units.
